(19) United States
(12) Patent Application Publication
(10) Pub. No.: US 2025/0303342 A1
(43) Pub. Date: Oct. 2, 2025

(54) CARBON DIOXIDE RECOVERY APPARATUS

(71) Applicant: HONDA MOTOR CO., LTD., Tokyo (JP)

(72) Inventor: Shumon HOSHINO, Saitama (JP)

(21) Appl. No.: 19/063,318

(22) Filed: Feb. 26, 2025

(30) Foreign Application Priority Data
Mar. 28, 2024 (JP) 2024-053118

(51) Int. Cl. B01D 53/04; B01D 53/34; B01D 53/62

(52) U.S. Cl. CPC B01D 53/04; B01D 53/346; B01D 53/62; B01D 2257/504

(57) ABSTRACT

Provided is a carbon dioxide recovery apparatus that makes it possible to effectively improve a recovery rate of carbon dioxide without adding complex parts. A carbon dioxide recovery apparatus includes: a fan that feeds a gas from the intake line to an adsorbent material inside a reactor; and a control device that executes, in an adsorption step where the adsorbent material is caused to adsorb carbon dioxide, first adsorption control of generating a gaseous flow by the fan in a state where an exhaust valve is caused to open the route in an exhaust line and second adsorption control of generating a gaseous flow to increase internal pressure in the reactor in a state where the exhaust valve is caused to close the route in the exhaust line after execution of the first adsorption control.

This application is based on and claims the benefit of priority from Japanese Patent Application No. 2024-053118, filed on 28 Mar. 2024, the content of which is incorporated herein by reference.

### BACKGROUND OF THE INVENTION

### Field of the Invention

The present invention relates to a carbon dioxide recovery apparatus.

### Related Art

Conventionally, such a technique has been known that recovers carbon dioxide from a gas such as atmospheric air containing the carbon dioxide. One example that describes a technique of this type is Japanese Unexamined Patent Application (Translation of PCT Application), Publication No. 2017-528318. Japanese Unexamined Patent Application (Translation of PCT Application), Publication No. 2017-528318 describes a method of separating gaseous carbon dioxide from a gas mixture through circulation style adsorption/desorption using an adsorption agent that adsorbs the gaseous carbon dioxide.

Patent Document 1: Japanese Unexamined Patent Application (Translation of PCT Application), Publication No. 2017-528318

### SUMMARY OF THE INVENTION

Possible methods for increasing a recovery amount of carbon dioxide include increasing a size of a device and improving capability of a pump and a heat source apparatus. However, changing a device configuration may require additional parts, for example, and may increase an operation cost of a carbon dioxide recovery apparatus. There has been a need for improvements in such conventional techniques in terms of avoiding an increase in cost due to changes in device configuration and in terms of improving a recovery rate of carbon dioxide.

An object of the present invention is to provide a carbon dioxide recovery apparatus that makes it possible to effectively improve a recovery rate of carbon dioxide without adding complex parts.
(1) The present invention relates to a carbon dioxide recovery apparatus (for example, a carbon dioxide recovery apparatus described later) including: a reactor (for example, a reactor 11, a reactor 11a, and a reactor 11b described later) internally including an adsorbent material (for example, an adsorbent material 12 described later); an intake line (for example, an intake line 101 and an intake line 101a described later) coupled to an upstream side of the reactor, through which a gas containing carbon dioxide passes; an exhaust line (for example, an exhaust line 102, an exhaust line 102a, and an exhaust line 102b described later) coupled to a downstream side of the reactor, through which the gas passes after passing through the adsorbent material; an exhaust opening-and-closing device (for example, an exhaust valve 31, an exhaust valve 31a, and an exhaust valve 31b described later) that is disposed in the exhaust line and that is able to open and close a route in the exhaust line; a gaseous flow generator (for example, a fan 61 described later) that generates a gaseous flow for feeding the gas from the intake line to the adsorbent material in the reactor; and a control device (for example, a control device 90 described later) that executes, in an adsorption step where the adsorbent material is caused to adsorb the carbon dioxide, first adsorption control of generating the gaseous flow by the gaseous flow generator in a state where the exhaust opening-and-closing device is caused to open the route in the exhaust line and second adsorption control of generating the gaseous flow to increase internal pressure in the reactor in a state where the exhaust opening-and-closing device is caused to close the route in the exhaust line after execution of the first adsorption control.
(2) In the carbon dioxide recovery apparatus in (1) described above, the gaseous flow generator may be a fan disposed on the upstream side of the reactor in the intake line.
(3) In the carbon dioxide recovery apparatus in (1) or (2) described above, the control device may cause, when a concentration of the carbon dioxide in the gas that has passed through the reactor exceeds a threshold value, transition to occur from the first adsorption control to the second adsorption control.
(4) In the carbon dioxide recovery apparatus in (1) or (2) described above, the control device may cause, after a predetermined period of time has passed after execution of the first adsorption control, transition to occur to the second adsorption control.
(5) In the carbon dioxide recovery apparatus in (1) or (2) described above, a plurality of the reactors (for example, a reactor 11a and a reactor 11b described later) may be disposed, and the control device may be able to execute each of the first adsorption control and the second adsorption control at a different timing for each of the reactors.

According to the present invention, it is possible to provide a carbon dioxide recovery apparatus that makes it possible to effectively improve a recovery rate of carbon dioxide without adding complex parts.

### BRIEF DESCRIPTION OF THE DRAWINGS

FIG. 1 is a schematic view illustrating a configuration of a carbon dioxide recovery apparatus according to an embodiment of the present invention;

FIG. 2 is a graph for describing a relationship between an adsorption amount of carbon dioxide and internal pressure in a reactor;

FIG. 3 is a flowchart illustrating an example of a flow of processing of adsorption control by a control device in the carbon dioxide recovery apparatus according to the present embodiment; and

FIG. 4 is a schematic view for describing a relationship between a fan and a plurality of reactors in a carbon dioxide recovery apparatus according to a modification example.

### DETAILED DESCRIPTION OF THE INVENTION

An embodiment of the present invention will now be described herein with reference to the accompanying drawings.

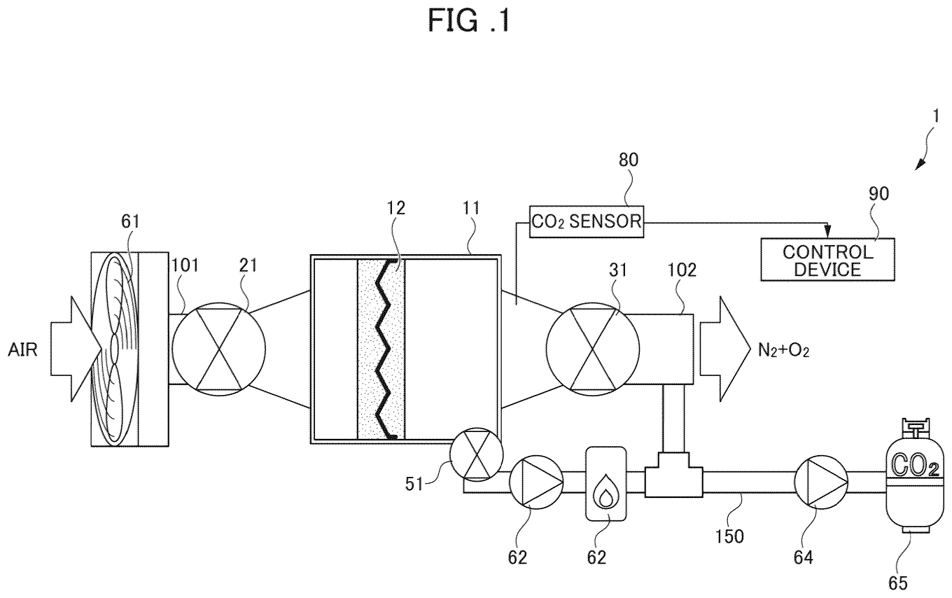

FIG. 1 is a schematic view illustrating a configuration of a carbon dioxide recovery apparatus 1 according to the embodiment of the present invention. The carbon dioxide recovery apparatus 1 is applied to, for example, a direct air recovery technique (direct air capture (DAC)) for recovering carbon dioxide in atmospheric air for lowering a concentration of the carbon dioxide in the atmospheric air. The carbon dioxide recovered by the carbon dioxide recovery apparatus 1 may be stored underground or may be re-utilized as a fuel or a material.

As illustrated in FIG. 1, the carbon dioxide recovery apparatus 1 includes a reactor 11, an intake line 101, a fan 61, an intake valve 21, an exhaust line 102, an exhaust valve 31, a carbon dioxide line 150, a recovery valve 51, a vacuum pump 62, a water restore 63, a compressor 64, a carbon dioxide tank 65, a carbon dioxide sensor 80, and a control device 90.

The reactor 11 internally includes an adsorbent material 12 for adsorbing carbon dioxide. The adsorbent material 12 is a particle member having characteristics of adsorbing carbon dioxide in a state at a low temperature (for example, within a range from −30° C. to 50° C.) and of desorbing (discharging) the carbon dioxide in a state at a high temperature (for example, within a range from 50° C. to 110° C.) and a low concentration of ambient carbon dioxide. An example of the adsorbent material 12 described above is a solid-amine carbon-dioxide-adsorbent material comprising, for example, an amine supported on a porous material such as silica.

The reactor 11 alternately executes an adsorption step of causing the adsorbent material 12 to adsorb carbon dioxide in an in-taken gas such as atmospheric air and a desorption step of causing the adsorbent material 12 to desorb the adsorbed carbon dioxide decompressed and being heated after having reached a vacuum state.

The intake line 101 is piping through which the gas such as atmospheric air containing carbon dioxide is in-taken and fed to the reactor 11. Through the intake line 101, the gas containing carbon dioxide is supplied to an interior of the reactor 11.

The fan 61 is disposed on an upstream side of the intake line 101 with respect to the reactor 11. As the fan 61 is driven, a flow of the gas from “intake” to “exhaust” with respect to the reactor 11 is generated through the intake line 101.

The intake valve 21 is disposed on an upstream side of the reactor 11 in the intake line 101. The intake valve 21 is controlled to reach an opened state where a route in the intake line 101 is opened in the adsorption step and is controlled to reach a closed state where the route in the intake line 101 is closed in the desorption step.

The exhaust line 102 is piping coupled to a downstream side of the reactor 11. The gas (air) after the adsorbent material 12 has adsorbed the carbon dioxide is discharged to outside via the exhaust line 102. The gas discharged via the exhaust line 102 has a higher percentage of nitrogen and oxygen as a result of the carbon dioxide being recovered.

The exhaust valve 31 is disposed in the exhaust line 102. The exhaust valve 31 is controlled to reach an opened state where a route in the exhaust line 102 is opened in the adsorption step and is controlled to reach a closed state where the route in the exhaust line 102 is closed in the desorption step.

The carbon dioxide line 150 is coupled to the reactor 11. The carbon dioxide line 150 is piping for recovering the carbon dioxide desorbed in the desorption step, through which the carbon dioxide at a high concentration passes.

The recovery valve 51 is disposed on a coupling portion between the carbon dioxide line 150 and the reactor 11. The recovery valve 51 is controlled to reach an opened state where the carbon dioxide line 150 and the interior of the reactor 11 are in communication with each other in the desorption step of recovering carbon dioxide and is controlled to reach a closed state where the carbon dioxide line 150 and the interior of the reactor 11 are isolated from each other in the adsorption step.

The vacuum pump 62 is disposed in the carbon dioxide line 150. As the vacuum pump 62 is driven, the carbon dioxide desorbed in the desorption step in the reactor 11 is sucked into the carbon dioxide line 150 and recovered.

The water restore 63 is disposed on a downstream side of the vacuum pump 62 in the carbon dioxide line 150. The water restore 63 cools the gas that has passed through the vacuum pump 62 to recover moisture from the gas to increase the concentration of the carbon dioxide.

The compressor 64 is disposed on a downstream side of the water restore 63 in the carbon dioxide line 150. The compressor 64 compresses the carbon dioxide at the high concentration, from which moisture has been recovered by the water restore 63, and feeds the compressed carbon dioxide to the carbon dioxide tank 65.

The carbon dioxide tank 65 is disposed on a downstream side of the compressor 64 in the carbon dioxide line 150. The carbon dioxide tank 65 is a vessel that stores the carbon dioxide recovered through the carbon dioxide line 150.

The carbon dioxide sensor 80 is a carbon dioxide concentration detector that detects the concentration of carbon dioxide at an outlet of the reactor 11. Information indicating the concentration of carbon dioxide, which is detected by the carbon dioxide sensor 80, is outputted to the control device 90 for use in determining end of adsorption.

The control device 90 controls, for example, operation of driving and stopping a device used for adsorbing and desorbing carbon dioxide. The control device 90 is, for example, a computer including a central processing unit (CPU), a read only memory (ROM), and a random access memory (RAM). The control device 90 may be solely configured, or a plurality of the control devices may be configured. Furthermore, the control device 90 may be configured by utilizing an electric circuit including a relay, for example.

Next, control of recovering carbon dioxide by the control device 90 will now be described herein. The control device 90 according to the present embodiment executes adsorption control that includes two types of parts, that is, first adsorption control and second adsorption control, in the adsorption step where the adsorbent material 12 is caused to adsorb carbon dioxide, achieving a high adsorption rate of carbon dioxide.

In the first adsorption control, the control device 90 executes control of causing both the intake valve 21 and the exhaust valve 31 to each reach the opened state and executes control of causing the recovery valve 51 to reach the closed state. Then, the control device 90 drives the fan 61 to feed a gas containing carbon dioxide through the intake line 101 to the adsorbent material 12 inside the reactor 11.

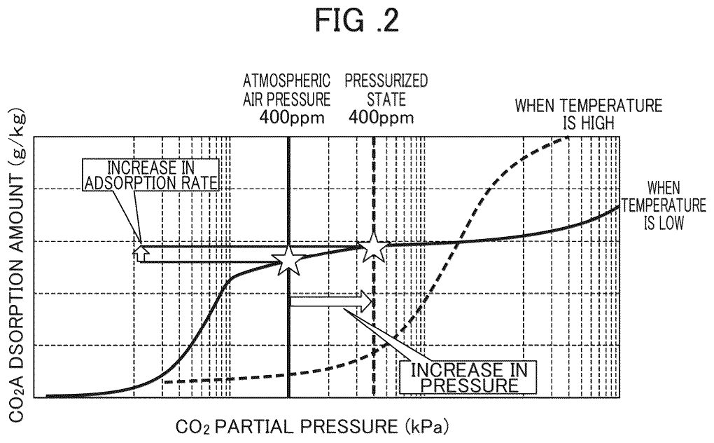

In the second adsorption control, the control device 90 executes control of increasing internal pressure in the reactor 11 to increase the adsorption rate of carbon dioxide to be greater than that in the first adsorption control. Note herein that, effects of increasing the adsorption rate by increasing the internal pressure in the reactor 11 will now be described herein with reference to FIG. 2. FIG. 2 is a graph for describing a relationship between an adsorption amount of carbon dioxide and the internal pressure in the reactor 11. In the graph illustrated in FIG. 2, a horizontal axis indicates partial pressure (kPa) of carbon dioxide and a vertical axis indicates the adsorption amount (g/kg) of carbon dioxide.

In FIG. 2, the relationship between the adsorption amount in the adsorbent material 12 and the partial pressure of carbon dioxide when a temperature of the adsorbent material 12 is low is illustrated by a solid line, and the relationship between the adsorption amount in the adsorbent material 12 and the partial pressure of carbon dioxide when the temperature of the adsorbent material 12 is high is illustrated by a broken line.

In the example illustrated in FIG. 2, a case where a supply concentration of carbon dioxide supplied to the reactor 11 is 400 ppm is considered. It can be understood that, even when the supply concentration of carbon dioxide is a constant concentration of 400 ppm, the adsorption amount in a state where the pressure inside the reactor 11 is identical to atmospheric air pressure and the adsorption amount in a state where the interior of the reactor 11 is pressurized differ from each other. In this example, it can be understood that there are increases in the adsorption amount in both cases when the temperature of the adsorbent material 12 is low and high. Note that, in the present embodiment, adsorption in the adsorbent material 12 takes place at a room temperature for improving the adsorption rate.

After the first adsorption control, the control device 90 executes the second adsorption control of increasing the internal pressure in the reactor 11 to increase the partial pressure of carbon dioxide, creating an environment where the carbon dioxide is easily adsorbed even in a final stage of the adsorption step. In the second adsorption control, the control device 90 executes a pressure adsorption step of keeping the opened state of the intake valve 21 and the closed state of the recovery valve 51, of changing the exhaust valve 31 from the opened state to the closed state, and of driving the fan 61.

Next, transition conditions for causing transition to occur from the first adsorption control to the second adsorption control will now be described herein. In the transition conditions in the present embodiment, it is set that the concentration of carbon dioxide at the outlet of the reactor 11 is equal to or above a threshold value set beforehand. As the first adsorption control is executed, adsorption reaction advances, and the adsorption amount indicates that it is approaching a saturated state, the adsorbent material 12 reaches a state where it is difficult to newly capture carbon dioxide. Therefore, the concentration of carbon dioxide in the gas that has passed through the adsorbent material 12 is higher when the saturated state is approached compared to before the saturated state is approached. The control device 90 monitors the concentration of carbon dioxide at the outlet of the reactor 11 to determine whether or not the adsorbent material 12 has approached the saturated state, and, when the saturated state is approached, causes transition to occur from the first adsorption control to the second adsorption control where the adsorption rate is high. The threshold value may be set through a demonstration experiment as the concentration of carbon dioxide, which indicates that the adsorbent material 12 has approached the saturated state, for example, or may be theoretically calculated based on a device configuration, for example.

Furthermore, it is also possible to set, in the transition conditions, that the first adsorption control has been executed for a predetermined period of time. The predetermined period of time is a period of time set beforehand during which the adsorbent material 12 approaches the saturated state. The predetermined period of time may be theoretically set based on data including an air blow amount of the fan 61, a period of time of air blow of the fan 61, and the concentration of carbon dioxide in atmospheric air, for example, or may be set based on an experiment using the carbon dioxide recovery apparatus 1, for example.

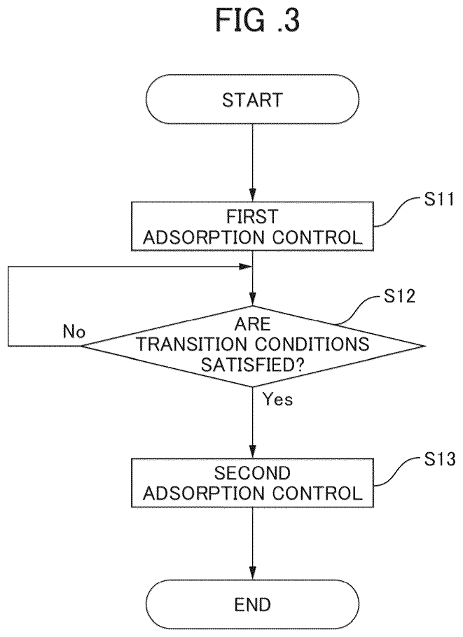

FIG. 3 is a flowchart illustrating an example of a flow of processing of adsorption control by the control device 90 in the carbon dioxide recovery apparatus 1 according to the present embodiment. The flowchart illustrated in FIG. 3 starts when a state of the adsorbent material 12 satisfies conditions for executing the adsorption step. Note that there is no particular limitation in the conditions for executing the adsorption step. For example, as a non-illustrated temperature sensor detects that the temperature of the adsorbent material 12 has reached a temperature (for example, the room temperature) appropriate for executing the adsorption step, the processing illustrated in FIG. 3 starts.

In step S11, the control device 90 executes the first adsorption control of feeding atmospheric air to the adsorbent material 12 having satisfied the execution conditions. As the first adsorption control is executed, a gaseous flow flowing into the intake line 101, the reactor 11, and the exhaust line 102 is generated as the fan 61 is driven, causing the adsorbent material 12 to adsorb carbon dioxide contained in a gas.

In step S12, the control device 90 determines whether or not the transition conditions for causing transition to occur from the first adsorption control to the second adsorption control are satisfied. It is assumed in here that, in the transition conditions, it is set that the concentration of carbon dioxide at the outlet of the reactor 11 is equal to or above the threshold value set beforehand.

When the concentration of carbon dioxide at the outlet of the reactor 11, which is detected by the carbon dioxide sensor 80, is equal to or above the threshold value set beforehand, the control device 90 causes the processing to proceed to step S13 (step S12; Yes). When the concentration of carbon dioxide, which is detected by the carbon dioxide sensor 80, is not equal to or above the threshold value set beforehand, the control device 90 continues monitoring of the carbon dioxide sensor 80 that detects the concentration of carbon dioxide at the outlet of the reactor 11 (step S12; No).

In step S13, the control device 90 causes transition to occur from the first adsorption control to the second adsorption control. As the first adsorption control is executed, the exhaust valve 31 on a side of the outlet of the reactor 11 reaches the closed state, the fan 61 continuously operates, and the internal pressure in the reactor 11 increases. As the internal pressure in the reactor 11 increases, the partial pressure of carbon dioxide increases, reaching a state where the adsorption amount increases, compared with a state under the atmospheric air pressure. After step S13 in the processing, the adsorption step ends. After the adsorption step, the desorption step of desorbing the carbon dioxide in the adsorbent material 12 in the reactor 11 is executed.

In the desorption step, the intake valve 21 and the exhaust valve 31 for the reactor 11 are closed, and the recovery valve 51 is opened. The vacuum pump 62 operates to intake a gas in the interior of the reactor 11 for decompression for reaching a vacuum state or for approaching the vacuum state. A non-illustrated heat source device supplies heat energy to the interior of the reactor 11, increasing the temperature of the adsorbent material 12 in the reactor 11. Through the control of increasing the temperature of the adsorbent material 12, the adsorbent material 12 is also heated to a predetermined temperature (for example, 80° C.) that is sufficient for the desorption step, desorbing the carbon dioxide adsorbed in the adsorbent material 12. Next, the vacuum pump 62 is driven, and the carbon dioxide desorbed through the carbon dioxide line 150 is stored in the carbon dioxide tank 65. After the desorption step, the adsorption step is executed again. In the carbon dioxide recovery apparatus 1, the adsorption step and the desorption step are alternately executed, and desorbed carbon dioxide is compressed and stored in the carbon dioxide tank 65, removing and recovering the carbon dioxide from air.

As described above, the carbon dioxide recovery apparatus 1 according to the present embodiment includes: the reactor 11 internally including the adsorbent material 12; the intake line 101 coupled to the upstream side of the reactor 11, through which a gas containing carbon dioxide passes; the exhaust line 102 coupled to the downstream side of the reactor 11, through which the gas passes after passing through the adsorbent material 12; the exhaust valve (exhaust opening-and-closing device) 31 that is disposed in the exhaust line 102 and that is able to open and close the route in the exhaust line 102; the fan (gaseous flow generator) 61 that generates a gaseous flow for feeding the gas from the intake line 101 to the adsorbent material 12 in the reactor 11; and the control device 90 that executes, in the adsorption step where the adsorbent material 12 is caused to adsorb the carbon dioxide, the first adsorption control of generating the gaseous flow by the fan 61 in a state where the exhaust valve 31 is caused to open the route in the exhaust line 102 and the second adsorption control of generating the gaseous flow to increase the internal pressure in the reactor 11 in a state where the exhaust valve 31 is caused to close the route in the exhaust line 102 after execution of the first adsorption control.

Thereby, in the second adsorption control, the fan 61 continues feeding of a gas in a state where the exhaust valve 31 closes the downstream side of the reactor 11, and the gas is not discharged through the exhaust line 102, increasing the internal pressure in the reactor 11. As the internal pressure in the reactor 11 increases, the partial pressure of carbon dioxide in the reactor 11 improves, increasing the adsorption amount per unit time in the adsorbent material 12. Furthermore, in the first adsorption control, the exhaust valve 31 is opened and the fan 61 continuously supplies a gas to the adsorbent material 12, making it possible to secure a total amount of a gas to be supplied to the adsorbent material 12 wholly in the adsorption step. Then, in a stage where adsorption of carbon dioxide in the adsorbent material 12 advances to a certain level and the adsorption rate lowers, it is possible to cause transition to occur to the second adsorption control where the adsorption rate is high, making it possible to achieve efficient recovery of carbon dioxide.

Furthermore, the gaseous flow generator according to the present embodiment is the fan 61 disposed on the upstream side of the reactor 11 in the intake line 101.

Thereby, it is possible to utilize the fan 61 for supplying a gas that is a target that undergoes adsorption to the adsorbent material 12, making it possible to execute the second adsorption control to increase the internal pressure in the reactor 11. Furthermore, in a configuration where the fan is disposed on the downstream side of the reactor 11, it is impossible to increase the internal pressure in the reactor 11 even when the exhaust valve 31 has reached the closed state and the fan is driven, requiring separately prepared piping for feeding a gas blown by the fan to the upstream side of the reactor 11. At this point, in the configuration of the present embodiment, where the fan 61 is disposed on the upstream side, it is possible to achieve such a configuration in which a gas blown by the fan 61 is used to increase the internal pressure in the reactor 11 without changing piping configuration, for example.

Furthermore, in the present embodiment, the control device 90 causes, when the concentration of carbon dioxide in a gas that has passed through the reactor 11 exceeds the threshold value, transition to occur from the first adsorption control to the second adsorption control.

Thereby, at a timing when the adsorbent material 12 has reached a state substantially identical to the saturated state, it is possible to cause transition to occur to the second adsorption control where the adsorption rate is high, making it possible to further improve the adsorption rate of carbon dioxide wholly in the adsorption step.

Furthermore, in the present embodiment, the control device 90 may cause, after a predetermined period of time has passed after execution of the first adsorption control, transition to occur to the second adsorption control.

Thereby, the control device 90 is able to use a timer, for example, to determine a timing of causing transition to occur from the first adsorption control to the second adsorption control without monitoring the concentration of carbon dioxide at the outlet of the reactor 11, making it possible to achieve a configuration for improving the adsorption rate with a simple configuration.

Although the example of the single reactor style where the one reactor 11 holding the adsorbent material 12 recovers carbon dioxide has been described above, it is possible to apply the present invention to a carbon dioxide recovery apparatus having a configuration where a plurality of the reactors 11 are used to execute the adsorption step and the desorption step in parallel.

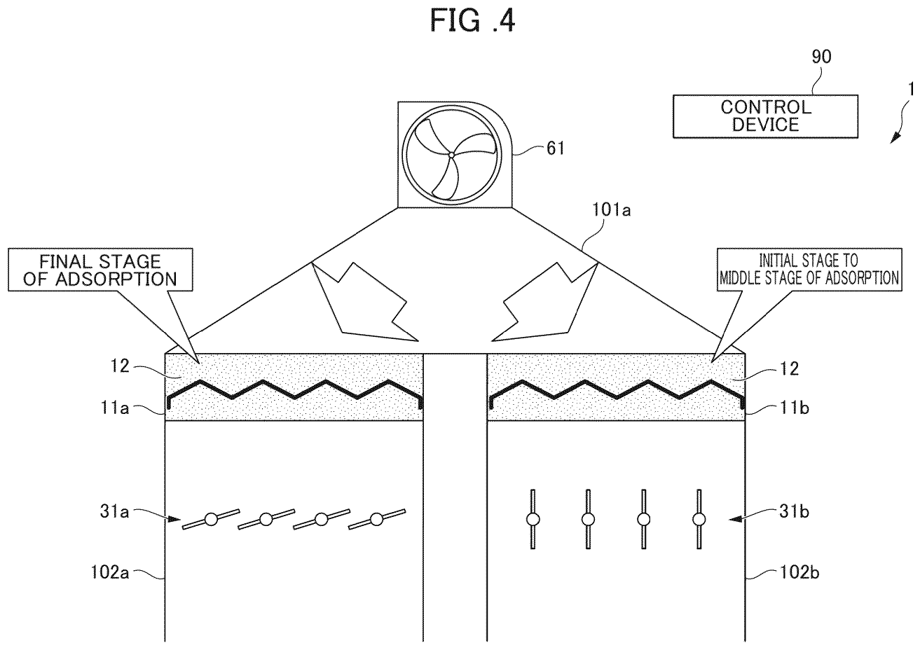

Next, an example of a carbon dioxide recovery apparatus 1a where a plurality of reactors, that is, a reactor 11a and a reactor 11b, are used will now be described herein with reference to FIG. 4. FIG. 4 is a schematic view for describing a relationship between the fan 61 and the plurality of reactors 11a, 11b in the carbon dioxide recovery apparatus 1 according to a modification example. Note that, in the below description, like reference numerals designate common or similar components to those in the embodiment described above, and their detailed descriptions may thus be omitted.

FIG. 4 illustrates, among the plurality of reactors 11, the reactor 11a in which the adsorption step almost reaches the final stage and thus the second adsorption control is executed and the reactor 11b in which the adsorption step is in progress from the initial stage to the middle stage and thus the first adsorption control is executed. Note that, in FIG. 4, illustration of a configuration for recovering carbon dioxide into the carbon dioxide tank 65 and a configuration such as the intake valve 21, for example, are omitted.

An intake line 101a in the carbon dioxide recovery apparatus la according to the modification example is branched and coupled to the plurality of reactors, that is, the reactor 11a and the reactor 11b, respectively. The fan 61 is disposed on an upstream side of the intake line 101a, and, as the fan 61 is driven, it is possible to generate a gaseous flow for feeding atmospheric air to each of the plurality of reactors, that is, the reactor 11a and the reactor 11b.

In the modification example, an exhaust line 102a is disposed on a downstream side of the reactor 11a, and an exhaust line 102b is disposed on a downstream side of the reactor 11b. An exhaust valve 31a is disposed in the exhaust line 102a, and an exhaust valve 31b is disposed in the exhaust line 102b.

The control device 90 independently controls each of the exhaust valve 31a and the exhaust valve 31b. Thereby, it is possible to execute the first adsorption control of causing the exhaust valve 31a corresponding to the reactor 11a in which the adsorption step almost reaches the final stage to reach a closed state, and of causing the exhaust valve 31b corresponding to the reactor 11b in which the adsorption step is in progress from the initial stage to the middle stage to reach an opened state.

In the modification example as described above, the plurality of reactors 11a to 11b are disposed, and the control device 90 is able to execute each of the first adsorption control and the second adsorption control at a different timing for each of the reactors 11a to 11b.

Thereby, it is possible to improve the adsorption rate, and it is possible to disperse a device load by executing the adsorption step and the desorption step in parallel in the plurality of reactors 11a to 11b, respectively.

Note that, although FIG. 4 has illustrated the two reactors, that is, the reactor 11a and the reactor 11b, the carbon dioxide recovery apparatus la according to the modification example may have a configuration including three or more reactors 11.

Although the embodiment of the present invention has been described, the present invention is not limited to the embodiment described above. Furthermore, the effects described in the embodiment and the modification example described above correspond to preferable effects merely listed, and effects of the present invention are not limited to those described in the embodiment and the modification example.

Although the embodiment and the modification example described above each have a configuration in which the fan 61 serving as the gaseous flow generator has been disposed on the upstream side of the reactor 11, the present invention is not limited to the configuration. It is also possible to apply such a configuration that a fan is disposed on a downstream side of a reactor, and a pump that increases the internal pressure in the reactor is separately disposed to serve as a gaseous flow generator. In this case, it is also possible to execute such control that the fan on the downstream side is caused to exert a suction force to supply atmospheric air to an adsorbent material in the first adsorption control, and the fan is stopped with respect to the reactor and the internal pressure in the reactor is increased using the pump in the second adsorption control. As described above, such a configuration may be applied in which a gaseous flow generator that generates a gaseous flow in the first adsorption control and a gaseous flow generator that uses a gaseous flow to increase the internal pressure in a reactor in the second adsorption control are separated and independent from each other.

### EXPLANATION OF REFERENCE NUMERALS

1 Carbon dioxide recovery apparatus
11, 11a, 11b Reactor
12 Adsorbent material
21 Intake valve
31, 31a, 31b Exhaust valve
61 Fan
90 Control device
101, 101a Intake line
102, 102a, 102b Exhaust line
150 Carbon dioxide line

What is claimed is:

1. A carbon dioxide recovery apparatus comprising:
a reactor internally including an adsorbent material;
an intake line coupled to an upstream side of the reactor, through which a gas containing carbon dioxide passes;
an exhaust line coupled to a downstream side of the reactor, through which the gas passes after passing through the adsorbent material;
an exhaust opening-and-closing device that is disposed in the exhaust line and that is able to open and close a route in the exhaust line;
a gaseous flow generator that generates a gaseous flow for feeding the gas from the intake line to the adsorbent material inside the reactor; and
a control device that executes, in an adsorption step where the adsorbent material is caused to adsorb the carbon dioxide, first adsorption control of generating the gaseous flow by the gaseous flow generator in a state where the exhaust opening-and-closing device is caused to open the route in the exhaust line and second adsorption control of generating the gaseous flow to increase internal pressure in the reactor in a state where the exhaust opening-and-closing device is caused to close the route in the exhaust line after execution of the first adsorption control.

2. The carbon dioxide recovery apparatus according to claim 1, wherein the gaseous flow generator is a fan disposed on the upstream side of the reactor in the intake line.

3. The carbon dioxide recovery apparatus according to claim 1, wherein the control device causes, when a concentration of the carbon dioxide in the gas that has passed through the reactor exceeds a threshold value, transition to occur from the first adsorption control to the second adsorption control.

4. The carbon dioxide recovery apparatus according to claim 1, wherein the control device causes, after a predetermined period of time has passed after execution of the first adsorption control, transition to occur to the second adsorption control.

5. The carbon dioxide recovery apparatus according to claim 1, wherein a plurality of the reactors are disposed, and the control device is able to execute each of the first adsorption control and the second adsorption control at a different timing for each of the reactors.
